(19) United States
(12) Patent Application Publication
(10) Pub. No.: US 2025/0289938 A1
(43) Pub. Date: Sep. 18, 2025

(54) PROCESS FOR MAKING A PRESSURE SENSITIVE ADHESIVE THAT PROVIDES SUBSTANTIAL VAPOR PERMEABILITY, AND RELATED SYSTEMS

(71) Applicant: VaproShield, LLC, Gig Harbor, WA (US)

(72) Inventors: Leland Snyder, Gig Harbor, WA (US); Kevin D. Nolan, Seattle, WA (US); Stephen Blackowicz, Hawthorn Woods, IL (US)

(73) Assignee: VaproShield, LLC, Gig Harbor, WA (US)

(21) Appl. No.: 18/861,048

(22) PCT Filed: Apr. 8, 2024
(86) PCT No.: PCT/US2024/023529

§ 371 Date: Oct. 28, 2024

Related U.S. Application Data
(60) Provisional application No. 63/495,252, filed on Apr. 10, 2023.

(51) Int. Cl. C08J 9/30; C09J 5/06; C09J 5/08

(52) U.S. Cl. CPC C08J 9/30; C09J 5/06; C09J 5/08; C08J 2300/105; C09J 2301/302; C09J 2301/50

(57) ABSTRACT

A method for foaming an adhesive includes injecting gas into an adhesive in the liquid state to decrease the density of the adhesive. The method then includes mixing the gas-infused adhesive to generate a foamed adhesive having many small bubbles throughout the adhesive, with at least 80% of the bubbles having a size of 0.005 microns or greater. The method then includes curing the foamed adhesive to preserve the size of each of the bubbles generated in the foamed adhesive.

### CROSS-REFERENCE TO RELATED APPLICATIONS

AND INCORPORATION BY REFERENCE

This application claims priority from U.S. Provisional Patent Application 63/495,252 filed 10 Apr. 2023 and titled “Process For Making A Pressure Sensitive Adhesive That Provides Substantial Vapor Permeability, And Related Systems”. This application also incorporates by this reference the entirety of U.S. Provisional Patent Application 63/495,252.

### BACKGROUND

Architects and engineers agree that buildings must be able to dry; however most commonly used building underlayments and membranes trap condensation and moisture in wall cavities which can lead to poor indoor air quality, energy deficiencies and costly building damage. The North American building industry spends around nine billion dollars each year repairing and litigating building damage from water and moisture. New materials used in building construction over the last 20 years are energy efficient, but have poor ventilation, resulting in toxic mold claims of over three billion dollars. Air leakage from such membranes can result in increased energy use of up to 30-40% in heating climates and 10-15% in cooling climates.

Proper building envelope design promotes continual drying by allowing moisture vapor to escape. Moisture can penetrate a building envelope through materials and rain/snow exposure during construction. General occupancy also adds to the moisture levels. Trapped moisture can cause lumber to rot, swell and distort, metal to corrode, and insulation to lose some of its insulative value. Any or all of these issues result in a high risk of mold, mildew, building deterioration, poor indoor air quality and health and safety risks to occupants. In some states, new requirements to increase energy efficiency in construction, increases the possibility of trapped moisture, when low or non-permeable air barriers are used.

Current building construction uses vapor permeable barrier sheets and/or membranes to form an envelope around walls and roofs to allow the transport of moisture into and out of buildings, and to control the movement of air through walls and roofs covered by the barrier sheets and/or membranes. Common commercial barrier sheets and membranes use adhesive which is applied to the sheet or membrane so that the same can be secured to a wall or roof. Problems which occur in these commercial usages is that the adhesive does not provide sufficient water vapor transmission, and thus the barrier sheets and membranes trap a substantial amount of moisture inside the wall, roof, and building.

To overcome this problem, many barrier sheets and membranes have the adhesive applied to a region whose area is less than the total area of the barrier sheet or membrane's total surface. In this way, the region of the barrier sheet or membrane where the adhesive is located has poor vapor transmission, while the other region of the barrier sheet or membrane has good vapor transmission. In this configuration, the vapor transmission of the whole barrier sheet or membrane is the average of the different regions. Unfortunately, actual vapor transmission through the barrier sheet or membrane is not uniform, which causes vapor trapped under the region of the barrier sheet or membrane where the adhesive is located to have to travel a longer, circuitous, more difficult route through the barrier sheet or membrane to escape. To address this problem some barrier sheets and membranes have small regions where the adhesive is located and larger regions free of adhesive. This unfortunately reduces the total adhesion of the barrier sheet or membrane to the wall or roof and allows the barrier sheet or membrane to be too easily separated from the wall or roof.

Another common way to overcome the problem resulting from poor vapor transmission of the adhesive is to foam the adhesive to generate bubbles within the adhesive. These bubbles then promote vapor transmission through the adhesive. Typically, foaming such adhesive is done by blistering the adhesive after placing the adhesive on the barrier sheet or membrane. Blistering the adhesive involves heating the adhesive to generate bubbles in the adhesive's microstructure. Unfortunately, the number and size of the bubbles formed by blistering the adhesive is difficult to control. Thus, it's difficult to consistently generate a uniformly foamed adhesive.

Thus, there is a need for an adhesive that provides water vapor permeability of 10 or more Perms while covering the entire surface of the barrier sheet or membrane.

### SUMMARY

In one aspect of the invention, a method for foaming an adhesive includes injecting gas into an adhesive in the liquid state to decrease the density of the adhesive. The method then includes mixing the gas-infused adhesive to generate a foamed adhesive having many small bubbles throughout the adhesive, with at least 80% of the bubbles having a size of 0.005 microns or greater. The method then includes curing the foamed adhesive to preserve the size of each of the bubbles generated in the foamed adhesive.

By injecting a gas into the adhesive while the adhesive is in the liquid state and then mixing the gas-infused adhesive, many small bubbles may be formed in the adhesive's microstructure without heating the adhesive. This allows the size of the many small bubbles to be more consistent with each other, and also allows one greater control over the size of the bubbles. Many small, consistently-sized bubbles in the foamed adhesive allows the foamed adhesive to more easily allow water vapor to pass through it, and thus improve the Perm value of the foamed adhesive. A Perm is a unit of measure that indicates the ease with which water vapor passes through an adhesive, and is determined by the processes specified in ASTM E96, E398 and F1249. The higher the number the greater the vapor permeance, or ease with which water vapor passes through. More specifically, a Perm value of 50 or more may be obtained with an adhesive that has been foamed by injecting a gas into the adhesive and then mixing the gas-infused adhesive. Many small, consistently-sized bubbles in the foamed adhesive also provides the foamed adhesive with greater adhesion than a blistered adhesive.

### BRIEF DESCRIPTION OF THE DRAWINGS

FIG. 1 shows a schematic view of a system for foaming an adhesive, according to an embodiment of the invention.

Each of FIGS. 2A and 2B shows a view of the system that foams an adhesive according to an embodiment of the invention. FIG. 2A shows a side view of the system; FIG. 2B shows a front view of the system.

FIG. 3 shows an exploded, schematic view of a mixer of the system shown in FIGS. 2A and 2B that mixes an adhesive according to an embodiment of the invention.

FIG. 4A shows a perspective view of a stator of the mixer shown in FIG. 3 that mixes an adhesive according to an embodiment of the invention.

FIG. 4B shows a perspective view of a rotor of the mixer shown in FIG. 3 that mixes an adhesive according to an embodiment of the invention.

FIG. 5 shows a cross-sectional view of a portion of the rotor and stator coupled in the mixer shown in FIG. 3 that mixes an adhesive according to an embodiment of the invention.

### DETAILED DESCRIPTION

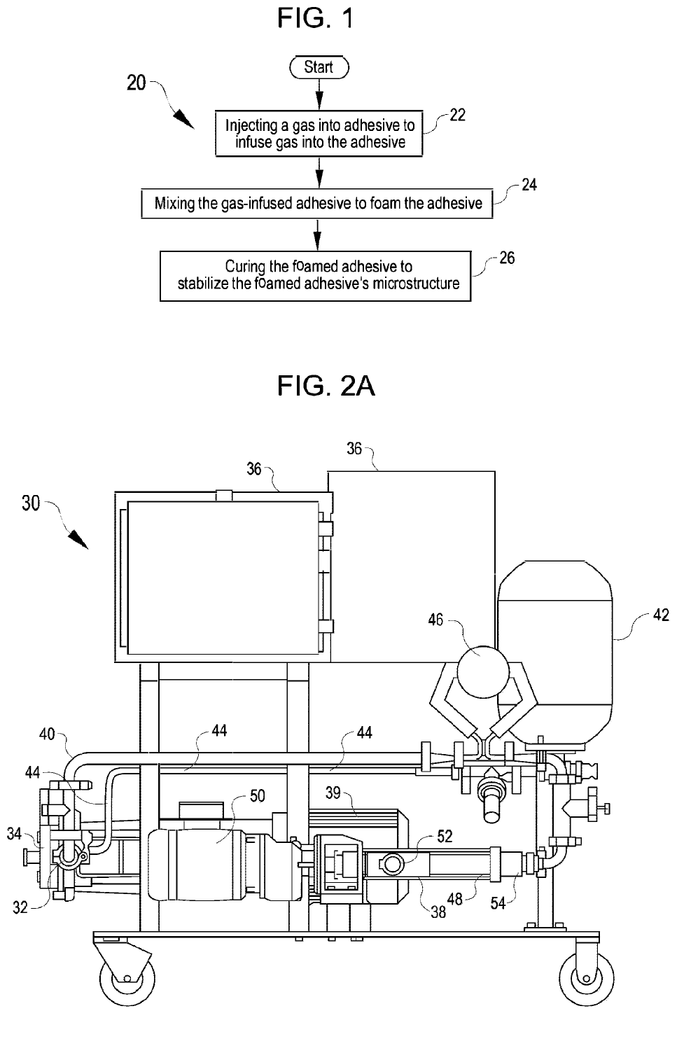

FIG. 1 shows a schematic view of a process 20 for foaming an adhesive, according to an embodiment of the invention. The process 20 includes, at step 22, injecting a gas into an adhesive in the liquid state to generate bubbles within the adhesive and decrease the density of the adhesive, and then, at step 24, mixing the gas-infused adhesive to complete or finalize the bubble formation in the adhesive. At this stage, the adhesive has a microstructure that includes many small bubbles. After the microstructure of the adhesive is generated, the process 20 includes, at step 26, curing the adhesive to preserve the size of each of the bubbles, and the distribution of the bubbles, in the adhesive's microstructure. The foamed adhesive that results from the process 20 has a density that may range between 15% and 90% of the density of the adhesive in the liquid state before foaming, and has a microstructure that includes many small pores (the bubbles). Here, the process 20 is performed as a continuous process in which liquid adhesive continually flows toward the curing step while gas is injected into the adhesive, and while the gas-infused adhesive is mixed. In other embodiments, the process 20 may be performed as a batch process in which an amount of liquid adhesive is held in a container while gas is injected into it, then, after all of the gas has been injected into the adhesive, all of the adhesive is mixed.

By injecting a gas into the adhesive while the adhesive is in the liquid state and then mixing the gas-infused adhesive, many small bubbles may be formed in the adhesive's microstructure without heating the adhesive. This allows the size of the many small bubbles to be more consistent with each other, and also allows one greater control over the size of the bubbles. Many small, consistently-sized bubbles in the foamed adhesive allows the foamed adhesive to more easily allow water vapor to pass through it, and thus improve the Perm value of the foamed adhesive. The greater the Perm value, the greater the vapor permeance, or ease with which water vapor may pass through the adhesive. In addition, many small, consistently-sized bubbles in the foamed adhesive provides the foamed adhesive with greater adhesion than an adhesive that has been blistered.

The density of the foamed adhesive is determined by the amount of gas injected into the liquid adhesive. Thus, controlling the amount of gas injected into the liquid adhesive allows one to control the density of the foamed adhesive. Here, the density of the foamed adhesive is specified as a percent of the density of the adhesive in the liquid state before gas is injected into it. Injecting a small amount of gas into the adhesive decreases the density of the foamed adhesive a correspondingly small amount.

Likewise, injecting a large amount of gas into the adhesive decreases the density of the foamed adhesive a correspondingly large amount. A system 30 (discussed in greater detail in conjunction with FIGS. 2A and 2B) performs the process 20 and includes an injector that injects a gas into the adhesive as the adhesive flows through the system 30. For example, in this and other embodiments, the injector injects air at a rate between 0.02 and 0.2 cubic feet per minute (cfm) into the adhesive flowing through the system 30 at a rate between 0.5 and 2.0 gallons per minute (gpm). When the injector injects air at a rate 0.2 cfm into the adhesive flowing through the system 30 at a rate of 0.5 gpm, the density of the foamed adhesive, before curing, is about 45% of the density of the liquid adhesive before the injector injects gas into it. And, when the injector injects air at a rate 0.02 cfm into the adhesive flowing through the system 30 at a rate of 2.0 gpm, the density of foamed adhesive, before curing, is about 95% of the density of the liquid adhesive before the injector injects gas into it. To generate a foamed adhesive having a density, before curing, of 70% of the density of the liquid adhesive before the injector injects gas into it, the injector injects air at a rate of 0.08 cfm into liquid adhesive flowing through the system 30 at a rate of 1.14 gpm.

The gas that the injector injects into the liquid adhesive may be any desired gas. For example, in this and other embodiments the gas is air because air is very easy to get and does not adversely react with the liquid adhesive while the air is in the adhesive. In other embodiments, the gas may be some other gas that is less reactive than the diatomic oxygen in air, such as carbon dioxide.

The microstructure of the foamed adhesive is finalized during the mixing of the gas-infused adhesive. The gas injected into the adhesive during the injection step forms bubbles in the adhesive that are not evenly distributed throughout the liquid adhesive. In addition, some of the gas injected into the liquid adhesive coalesces to form larger bubbles. These larger bubbles can be significantly larger than some of the other bubbles formed in the liquid adhesive. Thus, after the gas is injected into the liquid adhesive, the microstructure of the adhesive may include many bubbles whose sizes vary greatly and whose distribution throughout the adhesive is not consistent. To make the bubbles in the adhesive more consistent in size and more evenly distributed throughout the adhesive (or finalize the microstructure of the adhesive), the gas-infused adhesive is mixed by a mixer (discussed in greater detail in conjunction with FIGS. 2A-5) of the system 30. The mixer includes a stator and a rotor that moves relative to the stator to generate shear in the gas-infused adhesive as the gas-infused adhesive flows through the mixer. The speed of the rotor relative to the stator, and the configuration of the rotor and stator combination, affect the specific size and distribution of the bubbles that establish the microstructure of the foamed adhesive. For a given rotor and stator configuration, moving the rotor fast relative to the stator while the gas-infused adhesive flows slowly through the mixer will produce many small bubbles evenly distributed in the adhesive. Moving the rotor slowly relative to the stator while the gas-infused adhesive flows slowly through the mixer will produce many larger bubbles evenly distributed in the adhesive. Moving the rotor fast relative to the stator while the gas-infused adhesive flows rapidly through the mixer will produce many small bubbles that are not as evenly distributed in the adhesive as the adhesive that flows slowly through the mixer. Similarly, moving the rotor slowly relative to the stator while the gas-infused adhesive flows rapidly through the mixer will produce many larger bubbles that are not as evenly distributed in the adhesive as the adhesive that flows slowly through the mixer.

Still referring to FIG. 1, the microstructure of the foamed adhesive may include any number of pores (bubbles), each having any size. For example, in this and other embodiments the microstructure of the foamed adhesive may include a large number of small pores, each of which is substantially the same size as the other pores. More specifically, the microstructure may include pores whose size is 0.005 microns or greater. And even more specifically, the microstructure may include pores whose size ranges between 0.005 and 50 microns. A similar microstructure is disclosed in U.S. Pat. No. 11,186,985 issued to Bess et al., owned by VaproShield LLC, and incorporated in this patent application by reference. With a large number of small pores, the adhesive can provide substantial vapor permeability without sacrificing the adhesive's ability to adhere a construction membrane to a substrate of a wall or roof.

Still referring the FIG. 1, after the mixer of the system 30 finalizes the microstructure of the gas-infused adhesive, the adhesive is cured to stabilize or lock-in the finalized microstructure. For example, in this and other embodiments, the adhesive is spread onto a release liner and then dried at stage 26. The drying may include applying heat to the adhesive to increase the rate at which the adhesive dries, but in this and other embodiments the amount of heat applied is less than the amount of heat that would blister the adhesive. In addition, the heat is quickly applied to quickly increase the temperature of the adhesive to lock in the microstructure finalized in the mixing stage 24. In other embodiments, the adhesive may be dried without applying heat. During the curing step, the adhesive is typically spread onto the release liner such that its thickness is the desired thickness for the final application of the foamed adhesive.

Still referring to FIG. 1, once cured, the foamed adhesive may be applied to any desired structure for its final application. For example, in this and other embodiments the final application for the adhesive is on a membrane that is used as a component of a wall or roof envelop applied over a multitude of sheathing substrates. The membrane protects the sheathing and other components from the outside environment, such as moisture/rain, which could damage such components by penetrating and soaking the components. The membrane also protects the sheathing and other components by allowing water vapor trapped inside the construction to escape to the outside environment. The membrane may be configured as desired. For example, in this and other embodiments the membrane includes a fabric as disclosed in the previously referenced U.S. patents owned by VaproShield LLC, as well as U.S. Pat. No. 11,525,265 issued to Johnson et al., and U.S. Pat. No. 11,512,473 also issued to Johnson et al., each owned by VaproShield LLC and each specifically incorporated into this application by reference. More specifically, the membrane may be a nonwoven polyester fabric whose weight ranges from 60 grams per square meter (gsm) to 160 gsm. The thickness of the foamed adhesive applied to the membrane may range from 1.5 millimeters to 150 millimeters, depending on the total perms desired from the membrane and the adherence strength of the adhesive. Typically, the thicker the adhesive is for a given microstructure; the stronger the adherence strength, and the lower the vapor permeance or Perm rating.

Still referring to FIG. 1, the process 20 may be used to foam any desired adhesive. For example, in this and other embodiments the adhesive is an acrylic-based, pressure-sensitive adhesive. More specifically, the adhesive includes a polyacrylic polymer and is disclosed in greater detail in U.S. Pat. No. 10,899,107 issued to Bess, and U.S. Pat. No. 11,485, 112 issued to Bess at al., each owned by VaproShield LLC and each specifically incorporated into this application by reference. In this and other embodiments, the acrylic-based, pressure-sensitive adhesive, in liquid form and before gas is injected into, has a specific gravity of 1.1. Specific gravity is the ratio of the adhesive's density to the density of water. With a specific gravity of 1.1 the adhesive is denser than water. When the adhesive is foamed using the process 20, the adhesive is a tacky, foamed adhesive having a thickness of four millimeters and at least 50 Perms.

Each of FIGS. 2A and 2B shows a view of the system 30 that foams an adhesive according to an embodiment of the invention. FIG. 2A shows a side view of the system 30. FIG. 2B shows a front view of the system 30.

As mentioned in conjunction with FIG. 1, the system 30 includes an injector 32, a mixer 34, a controller 36, and a pump 38. The injector 32 injects gas into liquid adhesive that flows through the system 30 to generate bubbles in the adhesive. The mixer 34 mixes the gas-infused adhesive to complete or finalize the bubble formation in the adhesive. The controller 36 controls the flow rates of the gas and liquid adhesive, and the mixing rate of the mixer. And, the pump 38 urges the adhesive through the system 30.

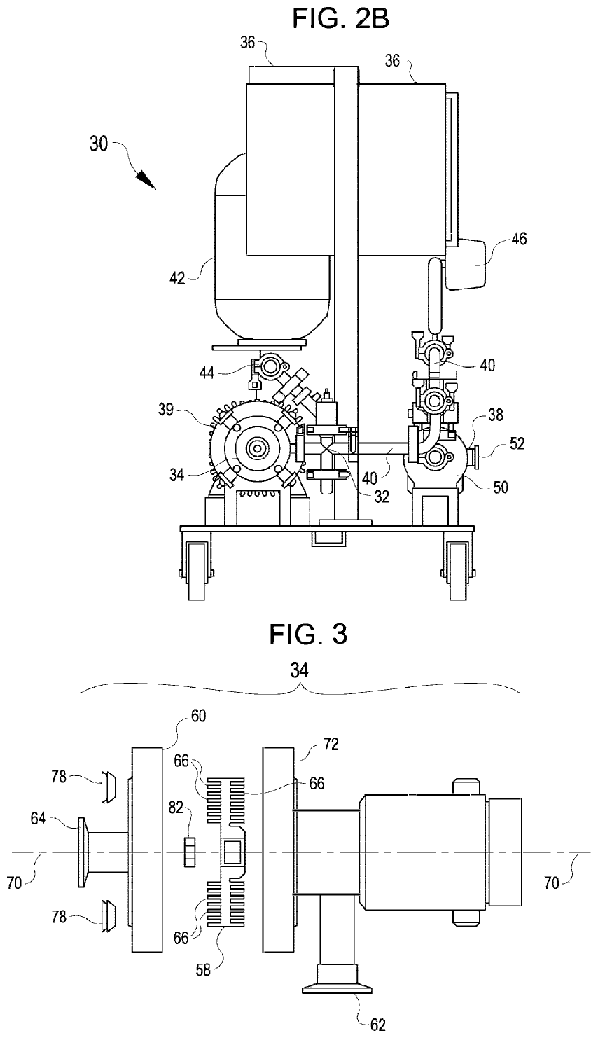

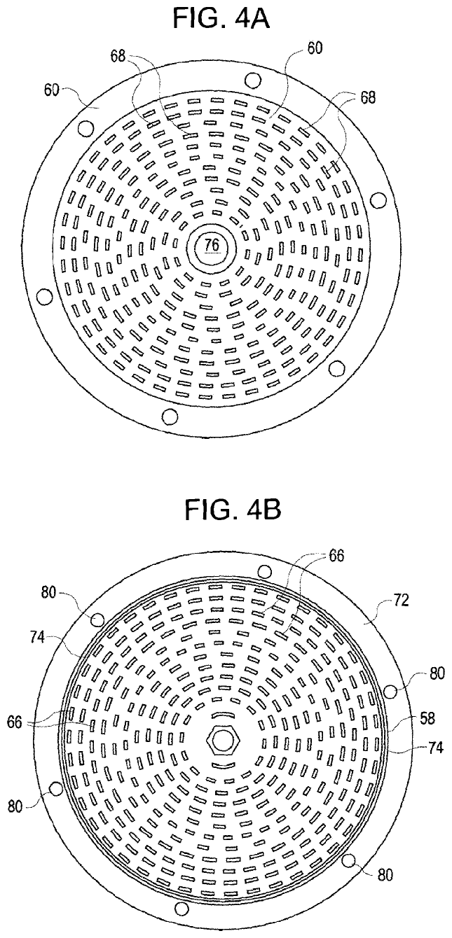

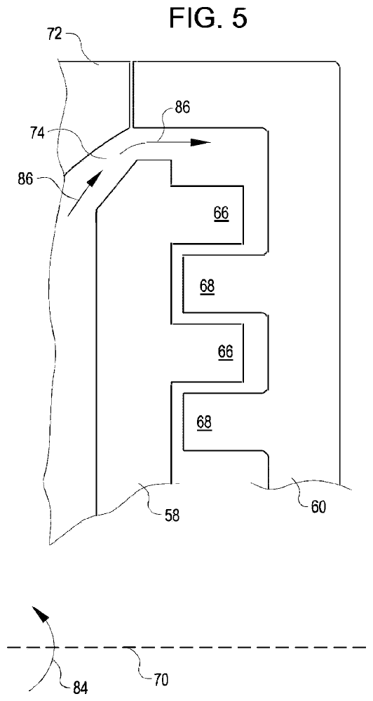

The mixer 34 may be any desired mixer capable of generating shear in the gas-infused adhesive to make the bubbles generated in the adhesive more consistent in size and more evenly distributed throughout the adhesive. For example, in this and other embodiments the mixer 34 (discussed in greater detail in conjunction with FIGS. 3-5) includes a rotor having many teeth (discussed in conjunction with FIGS. 3 and 4B), and a stator also having many teeth (discussed in conjunction with FIGS. 3 and 4A) arranged such that as the rotor moves relative to the stator, the teeth of the rotor move adjacent and near the teeth of the stator. When the gas-infused adhesive flows through the mixer 34, the adhesive flows between the rotor's teeth and the stator's teeth (discussed in conjunction with FIG. 5). As the gas-infused adhesive flows through the mixer and the rotor moves relative to the stator, the teeth of the rotor and the teeth of the stator shear the adhesive. The amount of shear applied to the adhesive depends on the speed at which the rotor's teeth move relative to the stator's teeth. In this and other embodiments, the rotor and stator each include a center, and are positioned relative to each other such that a single axis extends perpendicularly through both centers. A motor 39 powers the mixer and rotates the rotor relative to the stator at about 700 revolutions per minute (rpms). When gas-infused adhesive flows through the mixer 34, the adhesive first flows around the perimeter of the rotor. Then the adhesive flows between the rotor's teeth and the stator's teeth as it flows toward the colinear centers of the rotor and stator. Then the gas-infused adhesive flows through the center of the rotor to exit the mixer 34.

Still referring to FIGS. 2A and 2B, the injector 32 may be any desired injector capable of inserting gas into the flow of adhesive while the adhesive flows through the system 30. For example, in this and other embodiments the injector 32 includes a valve (not shown) having a hollow tube (not shown) that extends from the valve's exit and is disposed in the adhesive flowing through the pipe 40. The gas to be injected into the adhesive flows from the tank 42 through the line 44 to the injector 32. The valve that controls the flow of gas through the injector 32 may be located in or adjacent the tank 42, or adjacent the exit of the tube that is disposed in the flow of adhesive. In this and other embodiments, the controller 36 may open the valve and keep the valve open to provide a steady stream of gas into the flowing adhesive. In other embodiments, the controller 36 may sequentially open and close the valve to pulse the stream of gas into the flowing adhesive.

The controller 36 may be any desired controller capable of controlling the mixing rate of the mixer, and the flow rates of the gas and liquid adhesive. For example, in this and other embodiments the controller 36 includes control circuitry that has a user interface for allowing one to program one's desired adhesive flow rate, one's desired amount of gas to be injected into the adhesive, and the mixing rate of the mixer 34. The controller 36 also includes sensors to monitor the flow rates of the adhesive and the gas, as well as the mixing rate of the mixer 34, and then, in response to one or more of these desired rates inadvertently changing, the controller 36 may notify an operator of the system 30 and/or may change the one or more rates back to the desired rate. More specifically, the controller 36 includes a mass flow rate sensor 46 that senses the flow rate of the liquid adhesive, and a pressure sensor that sense the gas pressure inside the tank 42 that controller 36 can use to determine the flow rate of the gas being injected into the adhesive.

Still referring to FIGS. 2A and 2B, the pump 38 may be any desired pump capable of moving liquid adhesive having a specific gravity of 1.01 to 1.3 through the system 30. For example, in this and other embodiments the pump 38 includes a reciprocating piston 48 that is powered by an electric motor 50, and has an inlet 52 through which liquid adhesive enters the pump 38 and an outlet 54 through which the liquid adhesive leaves the pump 38. The motor 50 and reciprocating piston 48 are sized and configured to be able to move liquid adhesive through the system 30 at a flow rate within the range of 0.5 to 2.0 gpm.

Each of FIGS. 3, 4A and 4B shows a view of the mixer 34 of the system 30 shown in FIGS. 2A and 2B. FIG. 3 shows an exploded, schematic view of the mixer 34 of the system 30 shown in FIGS. 2A and 2B that mixes an adhesive according to an embodiment of the invention. FIG. 4A shows the stator of the mixer 34, according to an embodiment of the invention. And FIG. 4B shows the rotor of the mixer 34, according to an embodiment of the invention. As discussed in conjunction with FIGS. 2A and 2B, the movement of the rotor relative to the stator shears the gas-infused liquid adhesive as the adhesive flows through the mixer 34.

In this and other embodiments, the mixer 34 includes the rotor 58, the stator 60, an inlet 62, and an outlet 64. The rotor 58 includes many teeth 66 (also shown in FIG. 4B but only four labeled for clarity). The stator 60 also includes many teeth 68 (shown in FIG. 4A but only four labeled for clarity) configured such that the center of the rotor 58 and of the stator 60 lie on the axis 70 such that the rotor 58 and the stator 60 are colinear. Gas-infused adhesive enters the mixer 34 through the inlet 62 and then flows inside the housing 72 toward the perimeter of the rotor 58. The gas-infused adhesive then flows through the passage 74 between the housing 72 and the perimeter of the rotor 58, and enters the interface where the rotor's teeth 66 mesh with the stator's teeth 68. The gas-infused adhesive then flows toward the center of the stator 60 and through another passage 76 that leads to the outlet 64. The nuts 78 thread onto bolts 80 to releasably join the housing 72 to the stator 60 and keep the teeth 66 of the rotor 58 meshed with the teeth 68 of the stator. The nut 82 threads onto a driveshaft of the motor 39 (FIGS. 2A and 2B) to releasably couple the rotor 58 to the motor 39 so that when the motor 39 rotates the drive shaft the rotor 58 rotates, too.

FIG. 5 shows a cross-sectional view of a portion of the rotor 58 and stator 60 coupled in the mixer 34 shown in FIG. 3, according to an embodiment of the invention. When coupled, the teeth 66 and 68 mesh together and form an interface that the gas-infused adhesive flows through while the teeth 66 and 68 shear the adhesive. More specifically, as the rotor 58 rotates about the axis 70 in the direction of the arrow 84, the teeth 66 move relative to the teeth 68. And as gas-infused adhesive flows in the direction of the arrows 86, the adhesive flows through the gaps between the teeth 66 and 68. Because the rotor's teeth 66 move relative to the stator's teeth 68, the portion of the adhesive that contacts the sides of the teeth 66 is sheared or displaced relative to the portion of the adhesive that does not contact the side of the teeth. To help emphasize the shear in the adhesive flowing between the teeth 66 and 68, the portion of the adhesive that contacts the sides of the stator's teeth 68 is hindered from moving with the portion of the adhesive that contacts the sides of the rotor's teeth 66. As the gas-infused adhesive proceeds from the perimeter of the rotor 58 to the passage 76 at the center of the stator 60, the adhesive flows between multiple sets of teeth 66 and 68 and thus experiences multiple shearing actions. These shearing actions in the gas-infused adhesive chop up larger bubbles in the adhesive into many smaller bubbles, and spread the many bubbles throughout the adhesive to generate a more even distribution of many small bubbles throughout the adhesive. Then, the adhesive is cured to lock-in the size and distribution of the bubble's voids to generate a microstructure in the adhesive that includes many small distributed pores.

Generally, in this embodiment of the mixer 34 the size of the bubbles in the gas-infused adhesive is affected by the gap between the rotor's teeth 66 and the stator's teeth 68, and the speed at which the teeth 66 move relative to the teeth 68. The smaller the gap between each of the teeth 66 and 68, the smaller the bubbles will be in the adhesive. And the faster the teeth 66 move relative to the teeth 68, the smaller the bubbles will be in the adhesive. Because the rotor 58 rotates about the axis 70, the speed of the rotor's teeth 66 relative to the stator's teeth 68 depends on the distance of the teeth 66 from the axis 70. The teeth 66 that are adjacent the perimeter of the rotor move faster than the teeth 66 that are closure to the axis 70, and the teeth 66 that are adjacent the passage 76 at the center of the stator 60 move the slowest. Also, in this embodiment of the mixer 34, the distribution of the bubbles throughout the gas-infused adhesive depends on the number of rows of teeth 66 and 68. The more rows there are, the more evenly distributed throughout the adhesive the bubbles will be because more of the gas-infused adhesive flowing through the mixer 34 is exposed to the shearing action of the teeth 66 and 68.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A method for foaming an adhesive, the method comprising:
injecting gas into an adhesive in the liquid state to decrease the density of the adhesive;
mixing the gas-infused adhesive to generate a foamed adhesive having many small bubbles throughout the adhesive, with at least 80% of the bubbles having a size of 0.005 microns or greater;
curing the foamed adhesive to preserve the size of each of the bubbles generated in the foamed adhesive.

2. The method of claim 1 wherein the adhesive is an acrylic-based, pressure-sensitive adhesive.

3. The method of claim 1 wherein the adhesive has a specific gravity (index) of 1.1.

4. The method of claim 1 wherein injecting gas into the adhesive includes injecting air.

5. The method of claim 1 wherein injecting gas into the adhesive includes injecting the gas through a nozzle positioned in a chamber, while adhesive flows through the chamber.

6. The method of claim 5 wherein gas is injected into the adhesive at a rate between 0.2 and 0.02 cubic feet per minute.

7. The method of claim 5 wherein adhesive flows through the chamber at a rate between 0.5 and 2.0 gallons per minute.

8. The method of claim 5 wherein:
gas is injected into the adhesive at a rate of 0.08 cubic feet per minute, and
adhesive flows through the chamber at a rate of 1.14 gallons per minute.

9. The method of claim 1 wherein mixing the gas-infused adhesive includes shearing the adhesive between a stator of a mixer and a rotor of the mixer.

10. The method of claim 1 wherein mixing the gas infused adhesive includes:
pumping the gas-infused adhesive through a mixer having a stator and a rotor such that the gas-infused adhesive flows between a tooth of the stator and a tooth of the rotor, and
while the gas-infused adhesive flows between the tooth of the stator and the tooth of the rotor, moving the rotor of the mixer relative to the stator of the mixer such that the rotor's tooth passes close by the stator's tooth and shears the gas-infused adhesive.

11. The method of claim 1 wherein the foamed adhesive, before curing, has a relative density between 0.45 and 0.95 of the density of the adhesive in the liquid state before being injected with gas.

12. The method of claim 1 wherein the foamed adhesive, before curing, has a relative density of 0.7 of the density of the adhesive in the liquid state before being injected with gas.

13. The method of claim 1 wherein curing the foamed adhesive includes heating the foamed adhesive.

14. The method of claim 1 further comprising holding the foamed adhesive before curing the foamed adhesive.

15. The method of claim 1 further comprising applying the foamed adhesive to a substrate before curing the adhesive.

16. The method of claim 1 wherein mixing the gas-infused adhesive to generate a foamed adhesive includes having many small bubbles throughout the adhesive, with at least 80% of the bubbles having a size ranging between 0.005 and 50 microns.
